(19) United States
(12) Patent Application Publication
(10) Pub. No.: US 2014/0196511 A1
(43) Pub. Date: Jul. 17, 2014

(54) Lock Device and Method of Use

(71) Applicant: Ron R. Daniels, Missouri, TX (US)

(72) Inventor: Ron R. Daniels, Missouri, TX (US)

(21) Appl. No.: 14/156,182

(22) Filed: Jan. 15, 2014

Related U.S. Application Data
(60) Provisional application No. 61/753,657, filed on Jan. 17, 2013.

(51) Int. Cl. E05C 1/06

(52) U.S. Cl. CPC E05C 1/06
USPC 70/174; 29/428; 292/157

(57) ABSTRACT

The present invention, and inventive system, describes a locking system that reinforces an existing cover or tubular. In many embodiments of the present invention, the present invention reinforces an existing recessed cover by preventing the cover of a tubular or ring from being easily removed, or rotates by unauthorized persons and prevents any unauthorized personnel from accessing a locked down tubular. In one embodiment of the present invention, the inventive system is designed to maximize the overall strength of the locking unit for recessed covers or tubulars by using applied force on both the recessed cover and the circumference, curves, or straight, edge of the recessed unit or tubular interior.

### CROSS-REFERENCE TO RELATED APPLICATIONS

This application claims priority to U.S. provisional patent application 61/753,657, filed Jan. 17, 2013, which are incorporated by reference herein in their entirety.

### STATEMENT REGARDING FEDERALLY SPONSORED RESEARCH

Not applicable

### BACKGROUND

The present invention, and inventive system, is a new and novel locking mechanism that Prevents entry to recessed covers and tubular openings, which can include pressure valves, tubulars for transporting fluids, or other recessed covers with tubular orifices in them. Commonly, such items can be seen in public as pressure valves, gate valves, hatches, or door frames, bike steering columns, pipeline locks, and locking nuts, it is envisioned that other recessed covers and tubulars with interior walls could be locked with the present inventive device regardless of shape or size.

In one embodiment of the present invention, the present invention is installed and works in conjunction with an existing tubular wall, such as, a pressure valve wall to prevent theft of fluids flowing through the tubulars attached to the valve by securing the pressure valve and preventing rotation of the pressure valve head about the valve wall. In another embodiment of the present invention the present invention can prevent unauthorized access into circular, rounded, square, and trapezoidal or any other shaped recessed units or covers, such as, and by way of example a manhole, underground units, doors with door frames, or pipeline locks.

### SUMMARY

In various embodiments. the invention reinforces an existing tubular cover or valve with an interior wall by preventing unauthorized persons and/or the unauthorized operation of pressure valves, which may result in theft of the fluids flowing through those same valves. The inventive system is designed to maximize the overall strength of the locking unit for circular recessed covers, such as, butterfly valves by using applied force on both the recessed cover and the circumference edge of the interior wall of the valve, such as a pressure valve and/or applied force on both the tubular neck and valve stem associated with the fluid valve. In various embodiments of the present invention, the locking unit works by applying force through a locking screw that causes the spherical balls to be forced to extrude through the hole openings on the locking unit.

In various embodiments of the present invention the locking unit may be placed into either a recessed hole, or a tubular fitting. In some embodiments a locking screw is then screwed into the locking unit until the screw is tightened. Once locked in place, this locking unit should provide increased security of the recessed unit, such as manhole, sewer grate, or a tubular fitting, such as a butterfly valve or gate valve, by preventing the removal or recessed covers or the opening or closing of pressure valves. In various embodiments, the present invention has a tubular body which can be telescoped to reflect any preferred diameter and length of the item to be locked down.

In various embodiments of the present invention, the present invention maybe constructed with an elongated body with unique shapes and dimensions cut into the unit so as to fit into a variety of openings or tubulars with interior walls. In various embodiments, the present invention is not dependent on any unique characteristic added or removed from the locking unit, that does not affect the overall functionality of the locking screw, spherical balls and/or the hole openings for the spherical balls found on the present inventions base.

In various embodiments, the present invention works in conjunction with a pressure valve in which the present invention is installed into the tubular neck of the pressure valve. In various embodiments, the present invention is activated by tightening the locking screw which then causes the spherical bails to extrude through the hole openings in the body of the locking unit and thus makes contact with the outside circumference of the pressure valves tubular neck. In various embodiments of the present invention, this contact between the spherical balls and the tubular neck of the pressure valve prevent the free movement of the pressure valve, thus preventing the unauthorized transportation of fluids.

In one embodiment of the present invention, the inventive :system is designed to maximize the overall strength of the locking unit for recessed covers by using applied force on both the recessed cover and the circumference, curves, or straight, edge of the recessed frame or ring. In another embodiment of the present invention the present locking device locks on the top of a tubular with an interior wail therein preventing and movement or use of the tubular and preventing any materials from moving through the tubular.

In one embodiment of the present invention, a locking unit is placed into an existing tubular, by way of example, valve lock, into the top of the open tubular used to regulate the The present inventive device is then engaged with the tubular walls therein preventing the tubular from being utilized to have other objects pass through tubulars or other passages associated with the valves.

In one embodiment of the present invention, the present inventions an improved locking system comprising: a hollowed three dimensional base with a hole in a top region and multiple holes in the side region adjacent to the top region; several small spheres of larger diameter than the multiple holes in the side region; at least one large sphere of larger diameter that the small spheres; a locking screw which can be inserted into the hole in the top region of said base; and wherein said locking screw mechanically engages with said large sphere such that when rotated said locking screw causes the large sphere to move relative to the locking screw and to force said small spheres to extrude from said base via said multiple holes. In one embodiment of the present invention the hole in top region is threaded; and said locking screw is threaded to mechanically engage with said hole in top region. In one embodiment of the present invention, said base is substantially cylindrical in shape. In one embodiment of the present invention there is a key with a male interface in a unique geometric configuration; said locking screw further comprises a cover for said locking screw; said cover further comprising; a female interface with a unique geometric configuration designed to interface with said key.

In one embodiment of the present invention the present invention comprises a method for use of an improved locking system comprising; providing an improved locking system comprising; a hollowed three dimensional base with a hole in a top region and multiple holes in the side region adjacent to the top region; several small spheres of larger diameter than the multiple holes in the side region; at least one large sphere of larger diameter that the small spheres; a locking screw which can be inserted into the hole in the top region of said base; and providing a tubular with a cover with a hole and an inner tubular wall, placing the improved lock system into the cover with the hole so the lock system can mechanically engage with the interior of the tubular; rotating said locking screw mechanically so as to engage with said large sphere such that when rotated said locking screw causes the large sphere to move relative to the locking screw and to force said small spheres to extrude from said base via said multiple holes and engage the inner tubular wall. In one embodiment of the present invention, the method for use the improved locking system further comprises; count rotating said locking screw so that small spheres retract into said base.

### BRIEF DESCRIPTION OF THE DRAWINGS

For a more complete understanding of the present disclosure, and the advantages thereof, reference is now made to the following descriptions to be taken in conjunction with the accompanying drawings describing specific embodiments of the disclosure, wherein:

FIG. 1 illustrates one embodiment of the present invention in cross-section assembled View;

FIG. 2 illustrates one embodiment of the present invention n cross-section exploded view;

FIG. 3 illustrates one embodiment of the proprietary locking screw and key of the present invention;

FIG. 4 illustrates an embodiment of the present invention in a cross-sectional view being utilized in a pipe valve; and

FIG. 5 illustrates an embodiment of the present invention in which the base of the present invention is in a telescoped form.

### DETAILED DESCRIPTION

In the following description, certain details are set forth such as specific quantities, sizes, etc. . . . so as to provide a thorough understanding of the present embodiments disclosed herein. However, it will be evident to those of ordinary skill in the art that the present disclosure may be practiced without such specific details. In many cases, details concerning such considerations and the like have been omitted inasmuch as such details are not necessary to obtain a complete understanding of the present disclosure and are within the skills of persons of ordinary skill in the relevant art.

Referring to the drawings in general, it will be understood that the illustrations are for the purpose of describing particular embodiments of the disclosure and are not intended to he limiting thereto. Drawings are not necessarily to scale.

While most of the terms used herein will be recognizable to those of ordinary skill in the art, it should be understood, however, that when not explicitly defined, terms should be interpreted as adopting a meaning presently accepted by those of ordinary skill in the art. In cases where the construction of a term would render it meaningless or essentially meaningless, the definition should be taken from Webster's Dictionary. 11th Edition, 2008. Definitions and/or interpretations should not be incorporated from other patent applications, patents, or publications, related or not, unless specifically stated in this specification or if the incorporation is necessary for maintaining validity. “Ring” as defined in the present disclosure refers to any frame for a recessed cover, regardless of shape, “Tubular” as defined herein includes any object with solid exterior walls and a hollow interior with an opening. “Small sphere” as defined herein includes any object with solid three dimensional shape, which maybe spike shaped, spherical, cylindrical or other three dimensional shape. “Large sphere” as defined herein includes any object with solid three dimensional shape, which maybe spike shaped, spherical, cylindrical or other three dimensional shape.

One or more illustrative embodiments incorporating the invention disclosed herein are presented below. Applicants have created a revolutionary, and novel security system for recessed covers with frames, as well as tubulars, and orifices with interior walls.

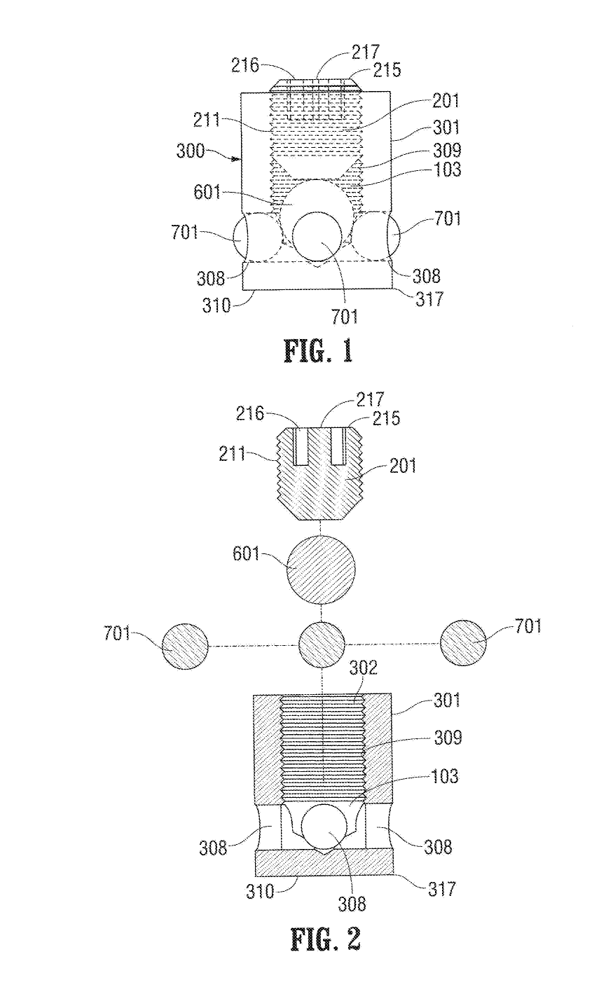

As shown in FIG. 1, one embodiment of the present inventive lock system 300 is shown in its assembled form via cross section view. In various embodiments of the assembled form of the lock system 300, the lock system 300 may have several parts including the locking screw 201, the large sphere(s) 601, the smaller spheres 701, and the base 301. As illustrated, in one embodiment of the present invention, the invention has a cylindrical base 301, although other three dimensional geometric shapes can be used in the present invention, including cubes, spheres, cones, cubes or three dimensional shapes, In several embodiments of the present invention, the base 301 may be constructed of iron, wood, steel, plastics, or other materials utilized to provide a base for suitable applications. As illustrated, in one embodiment of the present invention, the invention has a spherical large sphere(s) 601, although other three dimensional geometric shapes can be used in the present invention, including cubes, spheres, cones, cubes or other three dimensional shapes. In many embodiments of the present invention it is preferable that the large sphere(s) 601 be of a larger size than the small spheres 701. In several embodiments of the present invention, the large sphere(s) 601 may be constructed of iron, wood, steel, plastics, or other materials utilized to provide a sphere for suitable applications. As illustrated, in one embodiment of the present invention, the invention has a spherical small sphere(s) 701, although other three dimensional geometric shapes can be used in the present invention, including cubes, spheres, cones, cubes or other three dimensional shapes. In several embodiments of the present invention, the small sphere(s) may be constructed of iron, wood, steel, plastics, or other materials utilized to provide a small sphere for suitable applications. In several embodiments of the present invention, the locking screw 201 may be constructed of iron, wood, steel, plastics, or other materials utilized to provide a locking screw for suitable applications. In several ants of the present invention the locking screw 201 has threading 211 which can mechanically engage the locking threads 309 on the base 301 when in operation.

As shown in FIG. 1, in several embodiments, the present invention comprises a lock system 300 that is sizable enough to fit into the orifice 502 of a cover 507 (FIG. 4) such as a tubular, or recessed cover. In several embodiments of the present invention the orifice 502 has a ledge upon which the present locking system 300 sits when engaging the valve lock 1000. (FIG. 4). As illustrated in FIG. 4, a pipe valve. In some embodiments of the present invention, no ledge is required and the present locking system will directly engage the valve lock 1000.

FIG. 1 illustrates one embodiment of the present invention, or lock system 300, when assembled in cross sectional view. As illustrated, base 301 is preferably hollow with a solid bottom and hollow interior 103, and preferably constructed to have two sets of openings: the upper opening 302 and the small sphere openings 308 (FIG. 2). In many embodiments of the present invention the base 301 can be constructed of variable sizes such that it will fit into various size slots and holes as would be found in differing radius tubulars and covers. In various embodiments of the present invention, the base 301 may have locking threads 309 as are known in the art to mechanically engage the locking screw 201 when the present invention is engaged and assembled.

FIG. 1 illustrates one embodiment of the present invention, or lock system 300, when assembled in cross sectional view. In many embodiments of the present invention the locking screw 201 can be constructed of variable sizes such that it will fit into various size base 301 through upper opening 302. As illustrated, in several preferred embodiments of the present invention, the locking screw 201 is constructed to have threading 211 on the outer edges which can engage the counter locking threads 309 that are located, in several embodiments of the present invention, the upper opening 302 in a manner known in the art for threading engagement.

FIG. 1 also illustrates in one embodiment of the present invention, the small spheres 701 with a spherical shape, however, there may be other embodiments of the present invention in which the small spheres are beveled, square or other three dimensional geometric shape. Also illustrated is the large sphere(s) 601 with a spherical shape, however, there may be other embodiments of the present invention in which the large sphere(s) are beveled, square or other three dimensional geometric shape.

FIG. 2 illustrates one embodiment of the present invention in exploded view with partial cross section. As shown FIG. 2 the small sphere openings 308 pass entirely through the base 301 at point there in creating various orifices through which the small spheres 701 can extrude when the device is in operation. Bottom of base 310 is also illustrated upon which the small spheres 701 will rest when the lock system is assembled. Also illustrated is the hollow interior 103 of the lock system 300 as well as the locking threads 309. Also illustrated is the lower base portion 317.

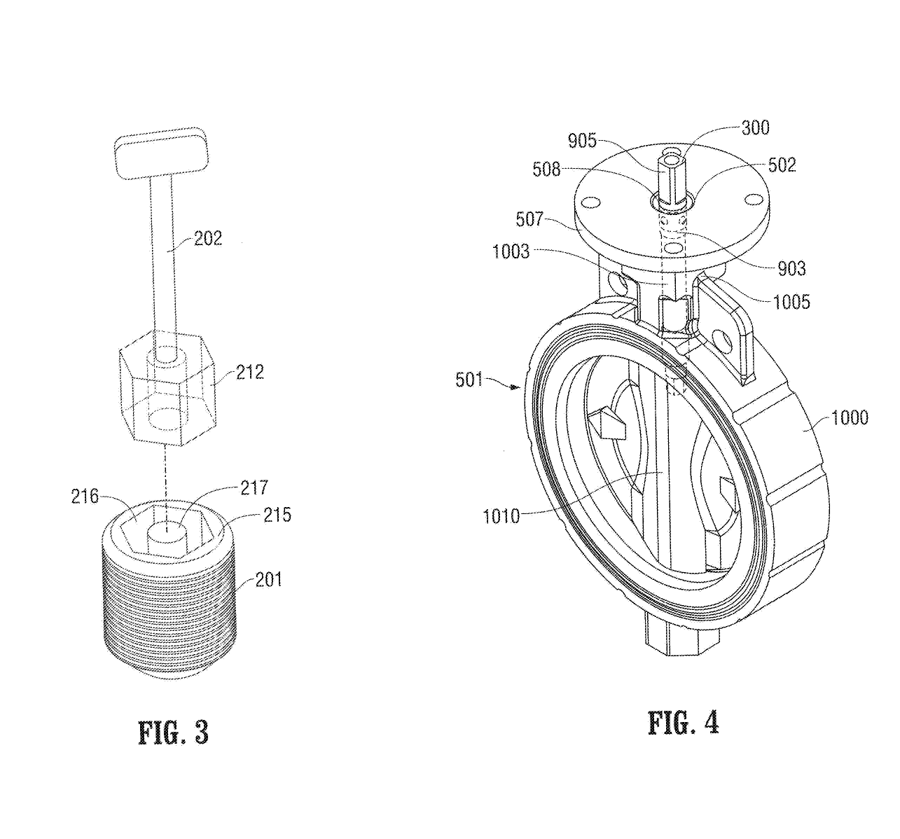

FIG. 2 illustrates one embodiment of the present invention in exploded view with partial cross section. As shown in FIG. 2 there are multiple small spheres 701 (as illustrated three in number) however, any number of multiple small spheres 701 can be utilized in the present invention. It is preferable in some embodiments that the small sphere openings 308 number the same as the small spheres 701, FIG. 2 also illustrates the large sphere(s) 601 as well as the locking screw (FIG. 3 as well). As illustrated in FIG. 2, in this embodiment of the present invention, the small sphere(s) openings 308 are of a smaller circumference than the small spheres 701. The smaller circumference prevents the small spheres 701 from falling out of the base 301, when the present inventive device is removed from a valve lock 1000 or just generally handled.

FIG. 3 illustrates one embodiment of the locking screw 201 and key 202. As illustrated in this embodiment, the locking screw 201 has a proprietary shaped cover 215 with an orifice 216. Orifice 216 can be of any geometric shape or design. Also illustrated is the key 202 with a male engaging member 212 which is preferably corresponding shaped to mechanically and releasably engage the orifice 216 such that the locking screw 201 may be rotated when the present lock system 300 is engaged. In one embodiment of the present inventive device, in operation this would mean that only persons with the proper tool could engage the locking screw 201. As the illustrated in FIG. 3 orifice 216 has a stylized peg 217 and hexagon shape, however, any geometric proprietary shape for the orifice 216 can be utilized.

FIG. 4 illustrates a cross section of one embodiment of the present locking system 300 as utilized on a valve lock 1000, as illustrated a butterfly valve. The present invention can be utilized for any hollow tubular needing to be locked or any hollow tubular used as a torqueing lock for any other device, by which rotation of the tubular can open or close the other device. As illustrated in this embodiment, the valve lock 1000 has an orifice 502 in the cover 507 into which the locking system 300 is placed when the locking system 300 is to be utilized with a valve lock 1000. Several embodiments of the present invention can be used with a cover 507 in which the orifice is preexisting, or in one which one is fabricated to be utilized with the present invention. As shown, the locking screw 201 is actually recessed in to the base 301. ergo the locking system is assembled. As illustrated, in this embodiment of the present invention, the small spheres 701 will engage the interior of the valve lock wall 1003 when the present invention is engaged thereby locking the present inventive device and preventing rotation of the cover 507 when the locking system 300 is engaged. In common applications a butterfly fly valve, such as valve 1000 works by rotating the stem 1005 thus allowing the valve to open and close. In several embodiments of the present invention the inventive locking system 300 is designed to actually lock the existing stem 1005 in place preventing the free movement of the stem. This is accomplished in several embodiments by small spheres 701 extruding from small sphere openings 308 and making communication with the neck, or inner wail of the butterfly valve. Thus said communication also prevents the stem from also being removed as well.

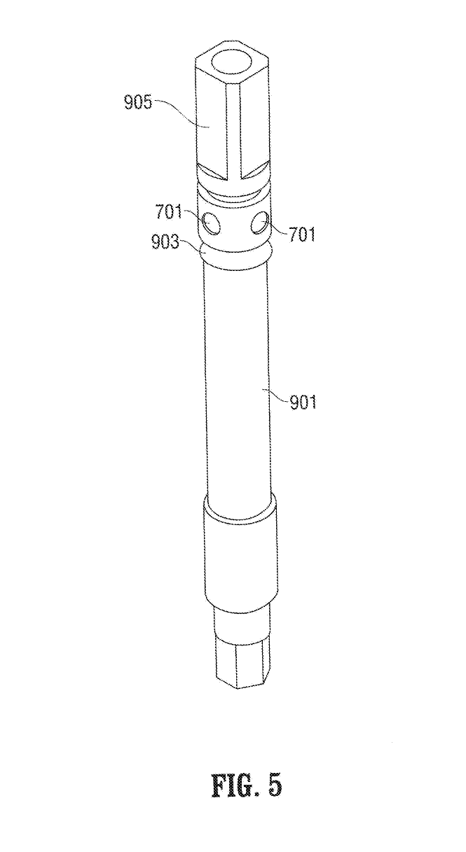

FIG. 5 illustrates another embodiment of the present invention with a telescoped, or elongated base 901 (which as illustrated, the lower portion 317 of the base 301 in this embodiment is substantially longer than base illustrated in FIG. 1.) The elongate base 901 is preferably designed to be in direct mechanical communication with valve turn cover 1010. It is preferable that elongated base is elongated is because it is then in direct mechanical communication with valve turn cover 1010. When the stem 1005 rotates left or right the valve turn cover 1010 rotates in the open and close position and by utilization of the present inventive locking system 300 the stem 1005 can be locked into an open and closes valve position. As further illustrated the elongated base 901 maybe constructed with an indentation 903 which is preferable designed to retain a rubber or washer as found in the industry to prevent any kind of liquid from improperly exiting the valve 1000. Also as illustrated extender 905 is used as, an option, to attach to an industry standard leveraging tool to assist with opening and closing the valve 1000 via the present inventive locking system 300.

In one embodiment of the present inventive device, the present inventive device is installed as follows. As shown in FIG. 4, in one embodiment of the present invention may be placed into the orifice 502 on the cover 507 of a valve lock 1000 or other tubular, or hole to be locked down. In some embodiments of the present invention, only one orifice 502 need be present on the cover 507. In some embodiments of the present invention, there are more than one orifice 502 on the cover 507, and therefore multiple lock systems 300 may be used. It is preferable, that the present invention is placed such that the locking screw 201 is facing distal to the small spheres 701 and away from the neck of the valve lock 1000. Once installed, in order to engage the present inventive device, the user need to insert the key 202 into the cover engagement cover 215 and rotate the key 202 in relation to the locking screw 201 therein causing the locking screw 201 to rotate and push downward on the large sphere(s) 601. In several embodiments of the present invention, the locking screw 11, when rotated, will push on the large sphere(s) 601 causing it to move the small spheres 701 outward and through the small sphere openings 308 and mechanically engage the interior lock wall 1003 of the valve lock 1000 therein preventing the attached cover 507 from rotating and allowing the change in material flow through a valve or tubular. Or in some embodiments preventing the cover 507 from being rotated and supplying torque to the locking valve lock wall 1003 and further rotation of that wall and torqueing of mechanisms below that wall such as axles, or other valve members.

In order to disengage the present inventive device the key 202 is reinserted into the cover engagement cover 215 and counter rotated thereby causing the locking screw 201 to counter-rotate upwards which allows the large sphere(s) 601 to move and small spheres 701 to retract into the base 301 and disengage from the cover 507. In some embodiments of the present invention, the counter rotation of cover 215 breaks the downward tension on sphere(s) 601 and thus allows small spheres 701 to retract back into small sphere openings 308. This break in tension allows for the free movement of the present invention.

As illustrated in FIGS. 1 and 2, in one embodiment of the present invention, the present invention is assembled in the following manner. In one embodiment, the invention has a cylindrical base 301, although other geometric shapes can be used in the present invention, including cubes, spheres, cones, cylinders or other solid shapes, into which there are preferably two sets of openings the upper opening 302 and the small sphere openings 308. In one preferred embodiment the small spheres 701 are placed into the hollow interior 103 of the base 301. It is preferable that the amount of small spheres 701 correspond with the same number of small sphere openings 308. The small sphere openings 308 are preferably designed to be of a smaller diameter than the small spheres 701, so the small spheres 701 will not fall out of the locking system 300 when the locking system 300 is in use. In some embodiments of the present invention, the small sphere openings 308 are pinched or mechanically squeezed to make a smaller circumference after the small spheres 701 are inserted, this prevents the small spheres 701 from falling out of the locking system 300, when the base is removed. At this point, in one embodiment of the invention, the large sphere(s) 601 are placed into the base 301. It is preferable that in many embodiments of the present invention the large sphere(s) 601 are of a larger diameter than the small spheres 701. In several embodiments of the present invention, several large sphere(s) 601 maybe used and stack on top of each other in the base 301. In several embodiments of the present invention, after the large sphere(s) 601 is inserted then the locking screw 201 with locking threading 211 is screwed onto the base 301 in mechanical communication with locking threads 309.

Although several preferred embodiments of the present invention have been described in detail herein, the invention is not limited hereto. It will be appreciated by those having ordinary skill in the art that various modifications can be made without materially departing from the novel and advantageous teachings of the invention. Accordingly, the embodiments disclosed herein are by way of example. It is to be understood that the scope of the invention is not to be limited thereby.

What is claimed is the following;

1. An improved locking system comprising;
A hollowed three dimensional base with a hole in a top region and multiple holes in the side region adjacent to the top region;
Several small spheres of larger diameter than the multiple holes in the side region;
At least one large sphere of larger diameter that he small spheres;
A locking screw which can be inserted into the hole in the top region of said base; and
Wherein said locking screw mechanically engage with said large sphere such that when rotated said locking screw causes the large sphere to move relative to the locking screw and to force said small spheres to extrude from said base via said multiple holes.

2. The improved locking system of claim 1 further comprising;
Said hole in top region is threaded; and
Said locking screw is threaded to mechanically engage with said hole in top region.

3. The improved locking system of claim 1 further comprising;
Said base is substantially cylindrical in shape.

4. The improved locking system of claim 1 further comprising;
A key with a male interface in a unique geometric configuration;
said locking screw further comprises a cover for said locking screw;
said cover further comprising:
a female interface with a unique geometric configuration designed to interface with said key.

5. The method for use of an improved locking system comprising;
Providing an improved locking system comprising;
a hollowed three dimensional base with a hole in a top region and multiple holes in the side region adjacent to the top region;
several small spheres of larger diameter than the multiple holes in the side region;
at least one large sphere of larger diameter that the small spheres;
a locking screw which can be inserted into the hole in the top region of said base; and
Providing a tubular with a cover with a hole and an inner tubular wall,
Placing said improved lock system into the cover with the hole so the said improved lock system can mechanically engage with the interior of the tubular;
Rotating said locking screw mechanically so as to engage with said large sphere such that when rotated said locking screw causes the large sphere to move relative to the locking screw and to force said small spheres to extrude from said base via said multiple holes and engage the inner tubular wall.

6. The method for use of an improved locking system of claim 5 further comprising; counter-rotating said locking screw so that small spheres retract into said base.
